(19) United States
(12) Patent Application Publication
(10) Pub. No.: US 2012/0233112 A1
(43) Pub. Date: Sep. 13, 2012

(54) DEVELOPING FAULT MODEL FROM UNSTRUCTURED TEXT DOCUMENTS

(75) Inventors: Dnyanesh Rajpathak, Bangalore (IN); Satnam Singh, Bangalore (IN)

(73) Assignee: GM GLOBAL TECHNOLOGY OPERATIONS LLC, Detroit, MI (US)

(21) Appl. No.: 13/045,310

(22) Filed: Mar. 10, 2011

(51) Int. Cl. G06N 5/02

(52) U.S. Cl. 706/54

(57) ABSTRACT

A method and system for developing fault models from unstructured text documents, such as text verbatim descriptions from customers and service technicians. An ontology, or data model, and heuristic rules are used to identify and extract descriptive terms from the text verbatim document. The descriptive terms are then classified into types, including symptoms, failure modes, and parts. Like-meaning but differently-worded descriptive terms are then merged using text similarity scoring techniques. The resultant symptoms, failure modes, parts, and correlations are then assembled into a fault model, which can be used for real-time fault diagnosis onboard a vehicle, or off-board at service shops.

### BACKGROUND OF THE INVENTION

1. Field of the Invention

This invention relates generally to a method and system for developing fault models and, more particularly, to a method and system for developing fault models from unstructured text document sources, such as text verbatim descriptions from customers and service technicians, which uses an ontology and heuristic rules to extract descriptive terms, including symptoms, failure modes, and parts, from the verbatim, also extracts the relationships among the descriptive terms, classifies the descriptive terms by type, merges like-meaning but differently-worded terms using text similarity scoring techniques, and assembles all of the extracted data into a resultant fault model.

2. Discussion of the Related Art

Modern vehicles are complex electro-mechanical systems that employ many sub-systems, components, devices, sensors and control modules, which pass operating information between and among each other using sophisticated algorithms and data buses. As with anything, these types of devices and algorithms are susceptible to errors, failures and faults that can affect the operation of the vehicle. To help manage this complexity, vehicle manufacturers develop a systematic framework to store the diagnostic information of the system in fault models, which match the various failure modes with the symptoms exhibited by the vehicle.

Vehicle manufacturers commonly develop fault models from a variety of different data sources. These data sources include engineering data, service procedure documents, text verbatim from customers and repair technicians, warranty data, and others. While all of these fault models can be useful tools for diagnosing and repairing problems, the development of the fault models can be time-consuming, labor intensive, and in some cases somewhat subjective. In addition, manually-created fault models may not consistently capture all of the failures modes, symptoms, and correlations which exist in the vehicle systems. Furthermore, a wealth of fault model data resides in customer textual verbatim comments, where it is often only partially extracted, or is overlooked altogether because of the difficult and error-prone nature of manually translating text into failure modes, symptoms, and correlation data.

There is a need for a method for developing fault models from different types of unstructured textual data sources, such as customer and dealer verbatim comments. Such a method could not only reduce the amount of time and effort required to create fault models, but could also produce fault models with more and better content, thus leading to more accurate failure mode diagnoses in the field, reduced repair time and cost, and improved customer satisfaction. Furthermore, it is a non-trivial task to extract different symptoms and/or failure modes that are written in the text verbatim mainly because of different types of noises observed in this data, such as abbreviated text entries, incomplete service repair records, and so on.

### SUMMARY OF THE INVENTION

In accordance with the teachings of the present invention, a method and system are disclosed for developing fault models from unstructured text documents, such as text verbatim descriptions from customers and service technicians. An ontology, or data model, and heuristic rules are used to identify and extract descriptive terms from the text verbatim document. The descriptive terms are then classified into types, including symptoms, failure modes, and parts. Like-meaning but differently-worded terms are then merged using text similarity scoring techniques. The resultant symptoms, failure modes, parts, and the correlations established among them are then assembled into a fault model, which can be used for real-time fault diagnosis onboard a vehicle, or off-board at service shops.

Additional features of the present invention will become apparent from the following description and appended claims, taken in conjunction with the accompanying drawings.

### BRIEF DESCRIPTION OF THE DRAWINGS

FIG. 1 is a schematic diagram of a system which takes unstructured text documents, automatically parses them using an appropriate process to produce a fault model, and uses the resultant fault model in both onboard and off-board systems;

FIG. 2 is a flow chart diagram of a method that can be used to develop fault models from unstructured documents, such as customer and service technician verbatim documents; and

FIG. 3 is a flow chart diagram of a method for extracting descriptive terms, including parts, symptoms, and failure modes, from the unstructured verbatim documents.

### DETAILED DESCRIPTION OF THE EMBODIMENTS

The following discussion of the embodiments of the invention directed to a method and system for developing fault models from text documents is merely exemplary in nature, and is in no way intended to limit the invention or its applications or uses. For example, the present invention has particular application for vehicle fault diagnosis. However, the invention is equally applicable to fault diagnosis in other industries, such as aerospace and heavy equipment, and to fault diagnosis in any mechanical, electrical, or electro-mechanical system where fault models are used.

Fault models have long been used by manufacturers of vehicles and other systems to document and understand the correlation between failure modes and associated symptoms. The failure mode and symptom data which is the basis of a fault model can be found in a variety of unstructured text verbatim, such as customer and dealer comments. But because unstructured text verbatim can be difficult and time-consuming to review for fault model content, many types of text verbatim have traditionally not been used to develop fault models for particular vehicles or systems, and thus manufacturers have not gained the benefit of all of the data contained in the unstructured text verbatim. The present invention provides a solution to this problem, by proposing a method and system for automatically developing fault models from unstructured text verbatim.

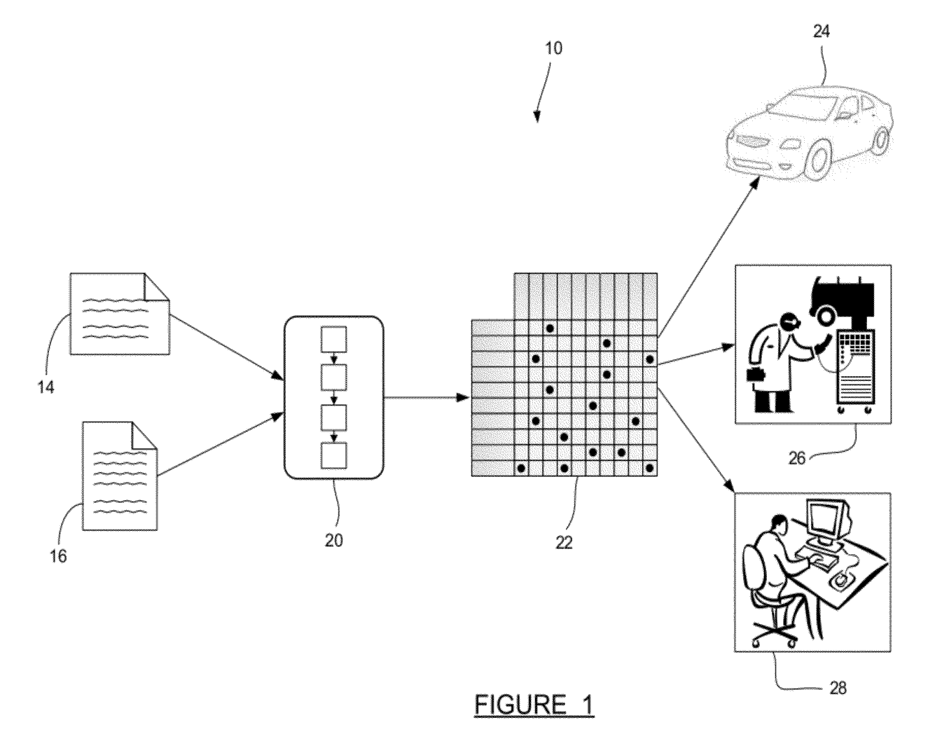

FIG. 1 is a schematic diagram of a system 10 which takes text document input, applies text-processing rules, parsing techniques, and other types of analysis to create a fault model, and uses the resultant fault model for diagnostic purposes, both onboard a vehicle and off-board. The system 10 is shown using a customer text verbatim 14 and service technician text verbatim 16 as input. Other types of unstructured text documents may also be used, but discussion of the verbatim 14 and 16 will be sufficient to explain the concepts involved in fault model development. The text verbatim 14 and 16 may include textual descriptions of symptoms exhibited by a vehicle and what was done to address the symptoms, both from customers and from technicians.

An unstructured text parsing module 20 can receive the text verbatim 14 and/or 16, and perform a set of parsing and analysis steps, described below, to produce the fault model 22. The fault model 22 contains a simplistic representation of the failure modes and symptoms described in the verbatim 14 and/or 16. As a digital database, the fault model 22 can be loaded into a processor onboard a vehicle 24 for real-time system monitoring, or used in a diagnostic tool 26 at a service facility. In the form of a database, the fault model 22 can also be used at a remote diagnostic center for real-time troubleshooting of vehicle problems. For example, vehicle symptom data and customer complaints could be sent via a telematics system to the remote diagnostic center, where a diagnostic reasoner could make a diagnosis using the fault model 22. Then a customer advisor could advise the driver of the vehicle 24 on the most appropriate course of action. As a printable document, the fault model 22 can read by a technician servicing a vehicle, or used by vehicle development personnel 28 for creation of improved service procedure documents and new vehicle and system designs.

A simplistic representation of the fault model 22 is a two-dimensional matrix that contains failure modes as rows, symptoms as columns, and a correlation value in the intersection of each row and column. Part identification data is typically contained in the failure modes. The correlation value contained in the intersection of a row and a column is commonly known as a causality weight. In the simplest case, the causality weights all have a value of either 0 or 1, where a 0 indicates no correlation between a particular failure mode and a particular symptom, and a 1 indicates a direct correlation between a particular failure mode and a particular symptom. However, causality weight values between 0 and 1 can also be used, and indicate the level of strength of the correlation between a particular failure mode and a particular symptom. Causality weight values of 0 and 1 are often known as hard causalities or correlations, while causality weight values between 0 and 1 are described as soft. Where more than one failure mode is associated with a particular symptom or set of symptoms, this is known as an ambiguity group.

In a more complete form, the fault model 22 could include additional matrix dimensions containing information such as customer complaint codes, trouble codes, diagnostic trouble codes (DTCs), operating parameters (also known as Parameter IDentifiers, or PIDs), signals and actions, as they relate to the failure modes and symptoms. For clarity, however, the text document-based fault model development methodology will be described in terms of the two primary matrix dimensions, namely failure modes and symptoms, with part information included as appropriate.

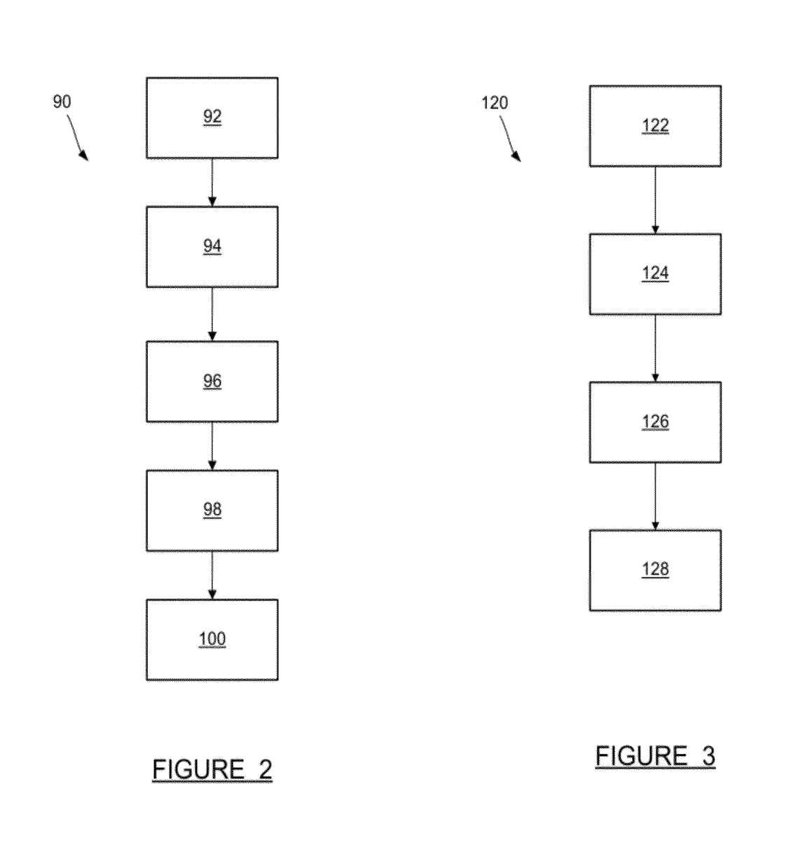

FIG. 2 is a flow chart diagram 90 of a method that can be used in the unstructured text parsing module 20 to create the fault model 22 from the text verbatim 14 and 16. At box 92, the customer text verbatim 14, the service technician text verbatim 16, or both are provided. The customer text verbatim 14 and service technician text verbatim 16 are intended to contain a compilation of a fairly large number of text verbatim descriptions related to a particular fault in a particular vehicle or system. That is, the verbatim 14 and 16 cannot just contain one or a few incident descriptions, which would be insufficient to perform extraction and statistical analysis. The more text records provided in the verbatim 14 and 16, the better the resultant quality of the fault model 22 is likely to be.

At box 94, an ontology and heuristic rules are used to extract descriptive terms of interest from the customer and technician text verbatim descriptions. An ontology is an information model that explicitly describes various entities, the properties associated with the entities, and the relationship types along with abstractions that exists in a domain along with the properties. In the context of fault model development, an ontology is a model of the parts, failure modes, symptoms, and the relationships that exist between these entities. Furthermore, it also consists of other parameters expected to be found in a vehicle or system. For example, an engine that won't start may be related to a failure mode in the fuel system, but is likely not related to a failure mode in the navigation system. Heuristics denotes the application of a general rule or a rule of thumb for solving a problem, without the exhaustive application of an algorithm. In the context of fault model development from text verbatim descriptions, heuristic rules can be applied to sentences, for example, to distinguish between a period used in an abbreviation and a period used at the end of a sentence.

FIG. 3 is a flow chart diagram 120 of a method for extracting descriptive terms from the verbatim 14 and 16, which is applied at the box 94. At box 122, sentence boundaries are detected using heuristics and other rules. Sentence boundaries are detected by finding full stop punctuation, that is, a period, a colon or a semicolon. However, punctuation marks must be evaluated in the context in which they are used before being determined to be a sentence delimiter. For example, periods may be used in abbreviations and acronyms, as well as ellipses or at the end of sentences. Punctuation marks used in abbreviations and other non-sentence-ending contexts are ignored, and sentence boundaries are defined using the remaining full stop punctuation as delimiters. The sentence boundaries defined at the box 122 allow words and phrases, such as symptoms and failure modes, to be grouped together and properly associated, as will be seen in a later step. Any suitable methodology may be used to detect sentence boundaries. One example is described in U.S. patent application Ser. No. 13/044,873, titled METHODOLOGY TO ESTABLISH TERM CO-RELATIONSHIP USING SENTENCE BOUNDARY DETECTION, filed Mar. 10, 2011, which is assigned to the assignee of this application and hereby incorporated by reference.

At box 124, unnecessary or superfluous words are removed, such as the articles “a”, “an”, and “the”. Other types of non-descriptive terms, and words such as “who”, “because”, and “becomes”, not relevant to fault model development, may also be removed at the box 124. A list of non-descriptive terms can be maintained and used at the box 124. The ontology, or data model, described previously, can also be used to separate the useful descriptive terms from the unnecessary non-descriptive terms.

At box 126, parts, symptoms, and failure modes are identified in the sentence fragments. Diagnostic trouble codes (DTCs) are one commonly-seen type of symptom. However, non-DTC symptoms are also important, and are also identified at the box 126. Examples of non-DTC symptoms include “no cold air from NC system”, and “rattle in door”. The ontology is used to identify the parts, symptoms, and failure modes at the box 126. At this point, the text verbatim 14 and 16 have been reduced to a document corpus containing many sentence fragments, where each sentence fragment consists of only descriptive terms, such as parts, symptoms, and failure modes.

At box 128, a frequency analysis is performed, to determine which of the parts, symptoms, and failure modes are valid for inclusion in the fault model 22. For each sentence fragment in the document corpus, a focal term is identified, typically a part. Here again, the ontology is used to identify parts. Then a word window is established on either side of the focal term, where the word window could be, for example, three terms to the left and right of the focal term. From within the word window of each sentence fragment, pairs are formed between a part and either a symptom or a failure mode. That is, a pair is formed between a particular part and a particular symptom from one sentence fragment, a pair is formed between a particular part and a particular failure mode from another sentence fragment, and so forth. After all of the sentence fragments have been analyzed and all pairs formed, the total frequency of occurrence of each pair is computed. That is, the number of times that a particular symptom or failure mode co-occurs with a particular part is counted. If the frequency of occurrence for a particular pair, which may be the occurrence count for that pair divided by the total number of pairs in all of the sentence fragments, exceeds a certain minimum frequency threshold, then the pair is determined to be a valid pair. Again, each pair consists of a part and a descriptive term—either a symptom or a failure mode. The frequency calculation of the box 128 is used to ensure that only valid and significant descriptive terms are included in the fault model 22.

The frequency analysis at the box 128 is the final step in the process of extracting text at the box 94 of the flow chart diagram 90. The output of the box 94 is a complete set of valid descriptive terms from the text verbatim documents 14 and 16. The descriptive terms include symptoms, failure modes, and the related parts. At box 96, the descriptive terms from the box 94 are classified into types. In one embodiment of the method, parts are deleted from the set of descriptive terms, leaving just the symptoms and failure modes. However, deleting parts is not necessary, as the parts can be left in the set of descriptive terms, in which case the parts can be carried through to the completion of the process and included in the fault model 22.

The descriptive terms are to be classified as symptoms, failure modes, and optionally, parts at the box 128. It is helpful to sub-classify symptoms into DTC symptoms and non-DTC symptoms. DTC symptoms are normally readily identified by the presence of the DTC identifier, which will have a specific standard format of a letter followed by four digits. For example, “DTC P0451” is related to fuel tank pressure sensor problems. Thus, rules can be defined which make identifying DTC symptoms straightforward, even in data extracted from an unstructured document. Non-DTC symptoms and failure modes can be matched from the ontology described previously. After classification at the box 96, the descriptive terms have been separated into DTC symptoms, non-DTC symptoms, failure modes, and optionally, parts.

In order to further illustrate the concept of parts, symptoms (both DTC and non-DTC), failure modes, and the relationships therebetween, a specific example will be explored. In this example, the part being considered is a fuel tank pressure sensor, or FTP sensor. Non-DTC symptoms which may be related to an FTP sensor problem include; reduced engine power, engine cuts out, engine will not start, unusual fuel gauge readings, and others. In addition, DTC symptoms, including one or more specific DTC's being captured, may also be present. Failure modes associated with the FTP sensor include; FTP sensor short to ground, FTP sensor short to voltage, FTP sensor internal short, FTP sensor stuck, FTP sensor open circuit, and others. Correlations between these symptoms and these failure modes are established using the method described above. For example, the failure mode “FTP sensor short to voltage” may be correlated to several DTC and non-DTC symptoms with a causality weight of 1, whereas the failure mode “FTP sensor short to ground” may only correlate with a single symptom. The fuel tank pressure sensor example illustrates not only the complexity of fault diagnosis in a vehicle comprising thousands of components and sub-systems, but also the importance of a complete and accurate fault model.

Returning to the flow chart diagram 90—at box 98, various text similarity measures can be employed to merge phrases, or descriptive terms, which are similar and may in fact mean the same thing. For example, a failure mode may be written by a technician as “fuel tank pressure sensor shorted”, “FTP short circuit”, or “fuel pressure sensor short circuit”; these three text strings mean the same thing, and the quality of the fault model 22 will be better if each failure mode or symptom is only included once—not multiple times with slightly different wording. The text similarity measures can include lexical similarity, probabilistic similarity, and hybrid lexical/probabilistic approaches. Acronyms can also be resolved using the ontology. These text similarity measures are known in the art, and need not be discussed in detail here. Various algorithms exist which are based on these text similarity measures, each of which provides a similarity score for each pair of text strings. In this way, a similarity score can be computed between pairs of symptoms, failure modes, and parts.

The similarity score for each pair of text strings can be compared to a threshold value to determine if the two text strings can be considered a match. If the similarity score for any pair of text strings meets or exceeds the threshold value, then the two text strings are determined to be the same, and the preferred text string is selected for both. Text string pairs with a very low similarity score can be automatically determined to be different, while text string pairs with similarity scores near but below the threshold can be reviewed by a subject matter expert for a determination of whether the two text strings represent the same symptom, failure mode, or part. After phrase merging at the box 98, a rationalized set of descriptive terms remains—including DTC symptoms, non-DTC symptoms, failure modes, and optionally, parts.

At box 100, the fault model 22 is assembled from the failure modes and symptoms as classified at the box 96, with items merged as identified at the box 98. The relationships or correlations between failure modes and symptoms, needed for fault model creation, are obtained from the sentence and part associativity retained from the text extraction steps at the box 94. Using the techniques described above, unstructured text verbatim, such as the customer text verbatim 14 and the service technician text verbatim 16, can be parsed and analyzed by the unstructured text parsing module 20 to produce the fault model 22. The fault model 22 can then be used, for example, to perform real-time fault diagnosis in an onboard computer in the vehicle 24, to perform off-board fault diagnosis using the diagnostic tool 26 or at a remote diagnostic center, or used by the vehicle development personnel 28 for updating service documents or designing future vehicles, systems, or components.

The benefits of being able to develop fault models from text documents are numerous. One significant benefit is the ability to reliably create high-fidelity fault models from text documents with a minimal amount of human effort. Also, by limiting the human involvement to the review and disposition of a small number of borderline items, the opportunity for human error or oversight is greatly reduced. Another benefit of being able to develop the fault model 22 from text verbatim is the ability to capture valuable customer complaint data which otherwise would likely not be used in fault model development. This can be done readily, once the diagnostic rules and ontology are developed as described above.

Finally, the methods disclosed herein make it possible to discover and document hidden or overlooked correlations, thus improving the quality of the resultant fault model data. The fault model 22 is a powerful document which can enable a vehicle manufacturer to increase first time fix rate, enhance customer satisfaction, reduce warranty costs, and improve future product designs.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for creating a fault model for a hardware or software system, said method comprising:
providing an unstructured text document containing diagnostic information about the hardware or software system;
extracting descriptive terms from the unstructured text document using an ontology and heuristic rules;
classifying the descriptive terms into types;
merging phrases in the descriptive terms which mean the same thing but are worded differently; and
assembling the fault model from the descriptive terms.

2. The method of claim 1 wherein the descriptive terms include symptoms, failure modes, and correlation values.

3. The method of claim 1 wherein extracting descriptive terms includes detecting sentence boundaries, removing non-descriptive words, identifying parts, symptoms, and failure modes, and performing frequency analysis to determine which of the parts, the symptoms, and the failure modes are valid for inclusion in the fault model.

4. The method of claim 3 wherein detecting sentence boundaries includes identifying full-stop punctuation marks, using the full-stop punctuation marks to define sentence boundaries, and defining correlations between the parts, the symptoms, and the failure modes based on the sentence boundaries.

5. The method of claim 1 wherein the ontology is a data model describing elements of the hardware or software system, including parts, symptoms, and failure modes, and relationships between the parts, the symptoms, and the failure modes.

6. The method of claim 1 wherein classifying the descriptive terms into types includes classifying the descriptive terms as Diagnostic Trouble Code (DTC) symptoms, non-DTC symptoms, failure modes, and parts.

7. The method of claim 1 wherein merging phrases in the descriptive terms includes using text similarity techniques to assign a similarity score to a pair of descriptive terms, comparing the similarity score to a threshold value, and equating the pair of descriptive terms if the similarity score exceeds the threshold value.

8. The method of claim 1 wherein assembling the fault model includes creating rows of failure modes, creating columns of symptoms, and placing correlation values in intersections of the rows and the columns.

9. The method of claim 1 wherein the hardware or software system is a vehicle or a vehicle sub-system.

10. The method of claim 9 wherein the unstructured text document contains text verbatim descriptions from a customer of the vehicle, or from a service technician who worked on the vehicle or the vehicle sub-system.

11. A method for creating a fault model for a vehicle or a vehicle sub-system, said method comprising:
providing a text verbatim document from a customer or a service technician, said document containing diagnostic information about the vehicle or the vehicle sub-system;
extracting descriptive terms from the text verbatim document using an ontology and heuristic rules;
classifying the descriptive terms into types, where the types include Diagnostic Trouble Code (DTC) symptoms, non-DTC symptoms, failure modes, and parts;
merging phrases in the descriptive terms which mean the same thing but are worded differently; and
assembling the fault model from the descriptive terms.

12. The method of claim 11 wherein extracting descriptive terms includes detecting sentence boundaries, removing non-descriptive words, identifying descriptive terms, and performing frequency analysis to determine which of the descriptive terms are valid for inclusion in the fault model.

13. The method of claim 11 wherein merging phrases in the descriptive terms includes using text similarity techniques to assign a similarity score to a pair of descriptive terms, comparing the similarity score to a threshold value, and equating the pair of descriptive terms if the similarity score exceeds the threshold value.

14. The method of claim 11 further comprising using the fault model for fault diagnosis in connection with the vehicle or the vehicle sub-system.

15. A system for creating a fault model, said system comprising:
means for providing an unstructured text document containing diagnostic information about a hardware or software system;
means for extracting descriptive terms from the unstructured text document using an ontology and heuristic rules;
means for classifying the descriptive terms into types;
means for merging phrases in the descriptive terms which mean the same thing but are worded differently; and
means for assembling the fault model from the descriptive terms.

16. The system of claim 15 wherein the means for extracting descriptive terms detects sentence boundaries, removes non-descriptive words, identifies parts, symptoms, and failure modes, and performs frequency analysis to determine which of the parts, the symptoms, and the failure modes are valid for inclusion in the fault model.

17. The system of claim 15 wherein the means for classifying the descriptive terms into types classifies the descriptive terms as Diagnostic Trouble Code (DTC) symptoms, non-DTC symptoms, failure modes, and parts.

18. The system of claim 15 wherein the means for merging phrases in the descriptive terms uses text similarity techniques to assign a similarity score to a pair of descriptive terms, compares the similarity score to a threshold value, and equates the pair of descriptive terms if the similarity score exceeds the threshold value.

19. The system of claim 15 wherein the means for assembling the fault model creates rows of failure modes, creates columns of symptoms, and places correlation values in intersections of the rows and the columns.

20. The system of claim 15 wherein the hardware or software system is a vehicle or a vehicle sub-system, and the unstructured text document contains text verbatim descriptions from a customer of the vehicle, or from a service technician who worked on the vehicle or the vehicle sub-system.
